(19) United States
(12) Patent Application Publication
(10) Pub. No.: US 2015/0201348 A1
(43) Pub. Date: Jul. 16, 2015

(54) METHOD FOR MANAGING THE CONFIGURATION OF A TELECOMMUNICATION NETWORK

(71) Applicant: Commissariat à L'Energie Atomique et aux Energies Alternatives, Paris (FR)

(72) Inventors: Rohit Gupta, Dresden (DE); Emilio Calvanese Strinati, Grenoble (FR); Antonio De Domenico, Frosinone (IT)

(73) Assignee: Commissariat à L'Energie Atomique et aux Energies Alternatives, Paris (FR)

(21) Appl. No.: 14/415,326

(22) PCT Filed: Jul. 18, 2013
(86) PCT No.: PCT/EP2013/065230

§ 371 Date: Jan. 16, 2015

(30) Foreign Application Priority Data
Jul. 18, 2012 (FR) 1256933

(51) Int. Cl. H04W 28/02; H04L 12/26; H04W 24/02

(52) U.S. Cl. CPC H04W 28/0231; H04W 24/02; H04L 43/062; H04L 43/0829

(57) ABSTRACT

The invention relates to a method for configuring a telecommunication network located in a geographic area in which at least one terminal is located that receives or transmits traffic relative to a service, the method including: acquiring information relative to the traffic received or transmitted by said at least one terminal, said information including a duration of the service requested or received by said terminal; determining, from the acquired data, a criterion that is characteristic of a possibility of delaying in time said requested or received service; estimating, from the acquired information and from said determined criterion, at least one profile of future traffic requests in said geographic area for a period of time following the acquisition; determining, from the estimated profile of traffic requests, a configuration of the network defining a profile of offers that is the closest to the profile of traffic requests; and configuring the network according to the configuration thus determined.

### GENERAL TECHNICAL FIELD

The invention relates to the field of wireless telecommunications and networks more particularly the management of a cellular, mesh and ad hoc telecommunications network.

### STATE OF THE ART

More and more frequent usage of terminals connected to a cellular network has caused an upsurge in traffic.

To counteract this rise in traffic, in the case of a cellular network, operators have boosted the density of cells in a given geographic region to offer a certain quality of service (QoS) to users.

A cell is defined by a base station which offers radio coverage for terminals inside the cell as defined.

It is specified that the term cell designates equally an attocell, a femtocell, a pico-cell, a micro-cell, or even a macro-cell.

One problem is that in a given geographic area the densification of cells has given rise to an increase in energy consumption of networks, with some areas of the network being over-equipped.

Solutions for defining spatio-temporally managing the network in a given geographic area are known.

Reference could be made to the document by Wei, Y., Song, M., Liu, B., Wang, X., & Li, Y. (2011, October): “Energy-efficient cooperative relaying and cognitive radio technologies to deliver green communication”, in Pervasive Computing and Applications (ICPCA), 2011 6th International Conference on (pp. 105-109), IEEE.

One solution is to manage the network as a function of the day or of the night based on the principle that the demand in traffic will be less at night than by day: the power of base stations can be reduced for example at night.

This approach is described in the following document: Chiaraviglio, L, Ciullo, D., Meo, M., & Marsan, M. A. (2009, September): “Energy-efficient management of UMTS access networks”, in Teletraffic Congress, 2009, ITC 21 2009. 21^{st} International (pp. 1-8), IEEE.

Other solutions are based on statistical information obtained via the traffic request passed to a given geographic region over a given time period. In this way, there are request profiles defined over and space, which manage the network.

But these solutions are unsatisfactory, as they do not take into consideration the traffic request in a given region in real time. So these solutions often result in or over-dimension or under-dimension the network, with under-dimensioning leading to degradation of the QoS.

Also, the problem of the taking the evolution of the traffic request into consideration in real time in a given region turns up again in wireless and ad-hoc mesh networks.

Consequently there is a need to be able to configure a mesh or ad hoc cellular network to limit energy costs and at the same time guarantee quality of service for users.

### PRESENTATION OF THE INVENTION

An aim of the invention is to manage a network as anticipated.

For this purpose, the invention proposes a method for configuration of a telecommunications network located in a geographic area, which has at least one terminal receiving or transmitting traffic relative to a service, the method comprising:
acquisition of information relative to the traffic received or sent by said at least one terminal, said information comprising a duration of the requested or received service by said terminal;
determination from acquired information from a criterion characteristic the possibility of deferring said requested or received service over time;
estimation, from acquired information and said determined criterion, at least one traffic request profile to reach the geographic area over a time period after the acquisition;
determination from the estimated traffic request profile of a configuration of the network defining an offer profile closest to the traffic request profile;
configuration of the network according to the configuration as determined.

The invention is advantageously completed by the following characteristics taken singly or in any technically possible combination:
the estimation step consists of updating, from acquired information, an initial request profile as a function of the profile of each user and previously initialised;
the determination step of the configuration of the network defining an offer profile closest to the traffic request profile integrates an optimisation step as a function of a predetermined criterion;
the predetermined criterion is that said configuration has minimal energy consumption for a given level of service quality;
the restriction in minimal energy consumption is a function of cost CF=Σᵢwᵢ*(Pᵢ/Pₘₐₓ) where: Pᵢ is at least one of the following parameters: capacity, timeframe, wait, packet loss rate, transition time, transitory energy, Pₘₐₓ is the maximal value of Pᵢ; wᵢ is the weight associated with each parameter Pᵢ;
the restriction in minimal energy consumption is a function of benefit BF=Σᵢwᵢ*(Eᵢ) where Eᵢ is the energy efficiency (bit/joule) associated with each component of the network, wᵢ is the weight associated with each Eᵢ;
the information relative to the traffic is sent at the same time as the traffic;
the acquisition step consists of employing a deep packet inspection technique on the traffic received to extract the information relative to the traffic;
each terminal comprises an application loaded into memory of the terminal, the method comprising an extraction step via application of information relative to said traffic, a transmission step of information extracted;
the configuration of the network is defined by the number of active base stations in the geographic area, the power of antennas of terminals and/or base stations and/or the itinerary relative to each traffic flow;
the configuration of the network is implemented either centralised or distributed.
   The advantages of the invention are many.

The invention is based on a prediction of traffic from information which when the management of the network is based on past measures are not taken into account.

In fact, precise and local estimation of the capacity requested reconfigures the network to avoid situations known as “out of service” and boost QoS. Also, reconfiguration can be done with the aim of optimising the network according to one or more parameters (such as energy efficiency) selected by the operator.

The invention applies to wireless networks: cellular (3G, GSM, GPRS, etc.), ad hoc and mesh networks.

### PRESENTATION OF FIGURES

Other characteristics, aims and advantages of the invention will emerge from the following description which is purely illustrative and non-limiting, and which must be seen in light of the appended drawings, in which:

FIG. 1 illustrates a cellular network deployed in a given geographic region;

FIG. 2 illustrates steps of a method according to the invention;

FIG. 3 illustrates an example of a traffic profile;

FIGS. 4a to 4e illustrate two embodiments of a method according to the invention;

FIG. 5 illustrates the energy consumption of a configuration of a network obtained according to the method of the invention in comparison with a configuration of a network obtained conventionally.

In all figures similar elements bear identical reference numerals.

### DETAILED DESCRIPTION OF THE INVENTION

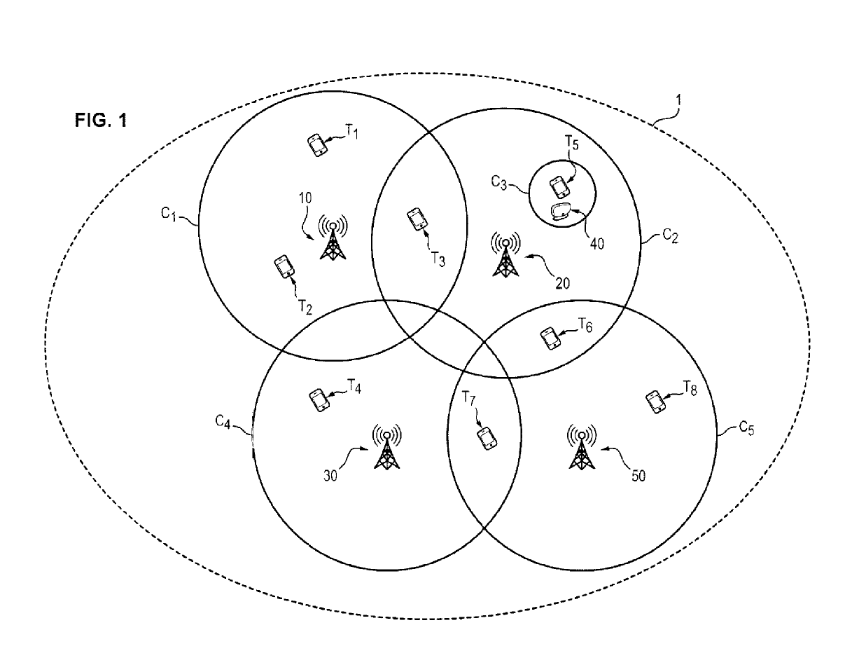

In relation to FIG. 1 a telecommunications cellular network comprises a plurality of base stations 10, 20, 30, 40, 50, arranged in a geographic area 1 containing at least one terminal T1, T2, T3, T4, T5, T6, T7, T8. Each base station 10, 20, 30, 40, 50 defines a cell C1, C2, C3, C4, C5.

The telecommunications network can be of mesh type and comprises at least one terminal located in a geographic area. This type of network differs from that of FIG. 1 in that it contains no base station.

Terminal means a telephony terminal a sensor, a computer, etc.

At least one terminal T1, T2, T3, T4, T5, T6, T7, T8 receives or transmits traffic directed to another terminal.

In the case of a cellular network (as illustrated in FIG. 1), the terminal sends or receives traffic by means of a base station 10, 20, 30, 40, 50. In this case, a terminal is linked to a base station.

The configuration can be set up centralised. For this, a controller is linked to all access points of the geographic area and acts as master of the network, the access points being slaves.

Alternatively, management can be carried out as distributed. In this case, the elements of the network of the geographic area communicate with each other to be configured relative to each other.

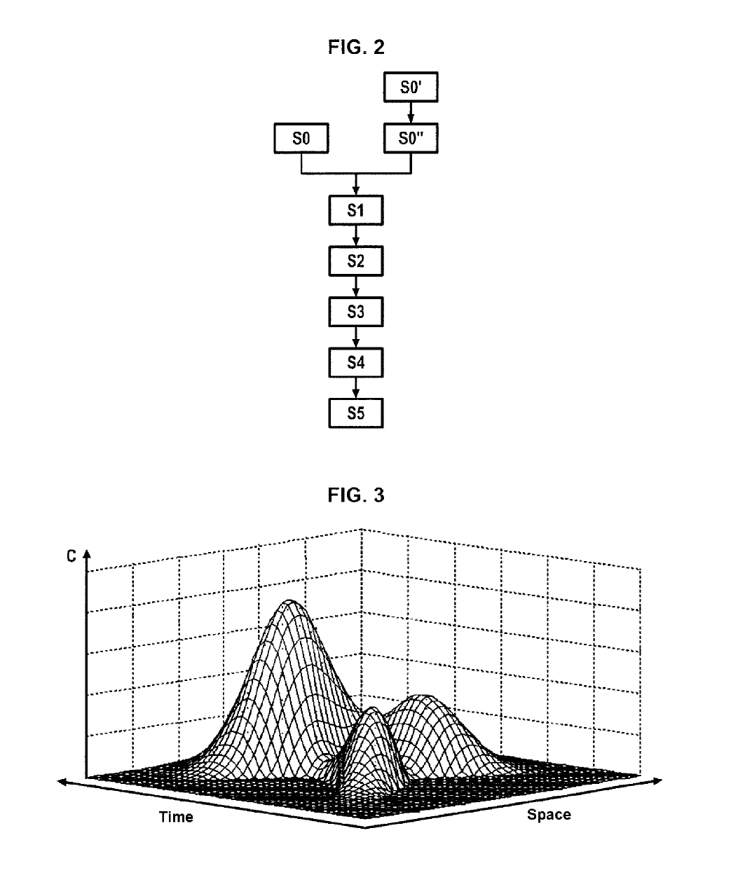

In relation to FIG. 2, in a management method, during a first step S1 information relative to the traffic sent or received by each terminal T1-T8 in the given geographic area is acquired.

It is specified here that traffic means packets of data (for example IP packets) transmitted or received by the terminal, the traffic corresponding to a requested or received service by the terminal.

Information relative to traffic relates to the content of the traffic and to the sending/receipt context of the traffic.

It is considered that traffic can originate from various applications (or services): telephony, video, SMS, video game.

More generally, these can be all types of services which need resources from the telecommunications network.

The context of sending/receipt of traffic can be the location of the terminal in the geographic area, the quality of the radio link, the type of communication (outside or inside what has a degree of mobility of the terminal in the geographic area), the base stations covering the mobile terminal in the geographic area (for example the terminal can be in an area covered by several base stations, in the case of a cellular network), attenuation of the radio signal, level of interference, etc.

The content of the traffic relates to the type of data coming from the services. The traffic is not identical if it is a telephone or a video call.

It is noted that the context is already utilised in various applications described in the documents below:
Document WO 03/049466 A1 (INTERDIGITAL TECH CORP [US]) (2003 Jun. 12);
Baldauf, M., Dustdar, S. & Rosenberg: “A survey on context aware Systems”, International Journal of Ad Hoc and Ubiquitous Computing, 2 (4), 263-27, 2007;
Moltchanov, B.; Knappmeyer, M.; Fuchs, O.; Paschetta, E,: “Context management and reasoning for adaptive service provisioning”, Ultra Modem Telecommunications & Workshops, 2009. ICUMT '09. International Conference on, October 2009;
Coutinho, N.; Condeixa, T.; Sargento, S.; Neto, A.; “Energy Efficiency as Input for Context-aware Group-based Communications”, Vol. 1, No. 6, pp. 329-353, April 2011;
Dean Kramer, Anna Kocurova, Samia Oussena, Tony Clark, and Peter Komisarczuk. 2011. “An extensible, self-contained, layered approach to context acquisition”, In Proceedings of the Third International Workshop on Middleware for Pervasive Mobile and Embedded Computing (M-MPAC '11). ACM, New York, N.Y., USA;
Zhiwen Yu, Xingshe Zhou, Daqing Zhang, Shoji Kajita, Kenji Mas: “Context-Aware Media Personalization”, Assistive Technology Research Series Volume 19, 2006 Smart Homes and Beyond—ICOST2006 4^{th} International Conference On Smart homes and Health Telematics.

The content and context can consequently let the network determine potential chaining of different types of content. This estimation is already implemented by the services of type “web streaming video”, (for example youtube®) and music (for example deezer®). These services propose certain types of content of video/music type which have a rapport with the preceding user requests. Also, the network can begin transmitting data relative to these predictions to reduce wait time and therefore improve the quality of the service. This case comes up especially for reading lists set up by a user.

The context information used here is information linking a terminal to its current use context, especially information stating that the terminal is inside or outside, or future, for example obtained from the history of the terminal, that is, information drawn from experience: for example regular shifts by the terminal, at particular time slots.

According to an embodiment, traffic sent or received by each terminal comprises information relative to the traffic.

According to this embodiment, advantageously the acquired information S1 comprises a duration of the requested or received service, a duration relative to the content.

With respect to the duration of the service, it can be of two orders: if the service requested is a reading service or continuous diffusion (“streaming”) wanted instantaneously (therefore which cannot be deferred), the duration of the service corresponds to the real duration of the information to be obtained by reading; if the service requested is likely to be deferred, the duration of the service can correspond to the quantity of data to be exchanged to provide this service.

Advantageously, this information S0 is inserted into the traffic directly on sending of the traffic. In this way, the information relative to traffic is transmitted explicitly by the terminal. In the case of a cellular network, information relative to the traffic can be inserted with signalling data. In this latter case the communication standard has to be adapted.

Alternatively or in addition, each terminal comprises an application loaded in memory of the terminal to retrieve information relative to traffic.

So, the method for configuration comprises an extraction step S0′ of information relative to traffic, and a transmission step S0″ of information relative to traffic. Such an application can be installed by the operators themselves before selling a terminal or can be provided to users so they install it on their terminal. In this last case a counterpart can be proposed to users (reduction on their subscription, for example). Therefore, it is the application which explicitly sends S0″ the information relative to traffic.

According to another embodiment, ensuring acquisition S1 data relative to traffic are extracted on receipt of traffic as such by a controller of the network, by a deep packet inspection (DPI) technique. Such a technique analyses traffic to establish statistics, to detect intrusions from spam or any other type of content. Such a technique is classically used for the Internet and is now applied to telecommunications networks. In this way, reference could be made to the document by R. Bendrath, “Global technology trends and national regulation: Explaining Variation in the Governance of Deep Packet Inspection,” International Studies Annual Convention, New York City, 15-18 Feb. 2009.

On completion of the acquisition step S1, a criterion characteristic of the possibility of deferring said requested or received service over time is determined at S2, from acquired information.

This criterion depends on the type of service according to whether this is real-time traffic or which can wait (for example large-volume email).

Next, a traffic request profile arriving in the geographic area over a time period after acquisition is estimated S3 from acquired information and the criterion as to the possibility or not of deferring the service.

The request profile is the capacity of the network requested in a given geographic area over a given period.

For this, the estimation step S3 consists of updating an initial request profile from information relative to the traffic acquired. This initial request profile is a function of the profile of each user.

The profile of each user comes in particular from past observations which take habits into account.

In other terms, the initial request profile P0 is the average traffic profile which characterises the given geographic region as a function of users present in the given geographic area.

Next, the new traffic request profile can be represented as a source of traffic to be served by the cellular network by queuing techniques and in particular technique called weighted fair queuing (WFQ) or else called priority queuing (PQ).

In this way, reference could be made to document: A. Parekh and R. Gallager: “A Generalized Processor-Sharing Approach to Flow Control in Integrated Services Networks: The Single-Node Case”, IEEE/ACM Transactions on Networking, Vol. 1, No 3, June 1993 and R. Rönngren and R. Ayani: “A comparative study of parallel and sequential priority queue algorithms”, ACM trans. Model. Comput. Simul. 7, 2, April 1997, pages 157-209.

The estimation S3 can be performed according to different time scales:
for a short duration, that is, for a duration of up to 1 minute, a duration comparable to the coherence time of the radio channel;
for an average duration, that is, for a duration of between 1 minute and 1 hour, a duration comparable to the average duration of a cellular-type application;
for a long duration, that is, for a duration greater than 1 hour.

Of course, the shorter the estimation duration, the greater the precision.

Therefore, the traffic request profile is a prediction of traffic to arrive at the geographic area and, contrary to known techniques which are based on past observations, the information relative to the content and to the context of incoming traffic is also used here.

FIG. 3 shows an example of a traffic request profile.

As illustrated in this figure the profile is three-dimensional: time, space capacity.

Once the request profile is obtained, a configuration of the network which produces an offer profile closest to the traffic request profile is determined S4.

This determination can be done under restriction. In this case, the offer profile closest to the request profile which best satisfies the restriction to be fixed will be determined.

Processes for automatic learning to determine the configuration of the network which best responds to the request profile can be used. In this respect, reference could be made to document WO 2007/057857 A1 (KONINKL PHILIPS ELECTRONICS NV [NL]. PHILIPS CORP [US]. RIBAS SALVADOR) (2007 May 24).

Configuration of the network is defined by all base stations activated and by their characteristics (number of antennas, power, calculation and cooperation capacity between base stations, etc.).

According to an embodiment, the restriction can be that the energy consumption of the configuration of the network ensuring a given level of QoS is minimal. In this way, the restriction on the offer profile ensures the required quality of service and the restriction on configuration ensures minimal energy consumption.

The restriction on the configuration of the network for having the minimal energy consumption can be defined either by a function of cost or by a function of benefit or again by a function of gain.

The function of cost can be defined by CF=Σᵢwᵢ*(Pᵢ/Pₘₐₓ) where Pᵢ is at least one of the following parameters: capacity, timeframe, wait, packet loss rate, transition time, transitory energy, Pₘₐₓ is the maximal value of Pᵢ, wᵢ is the weight associated with each parameter Pᵢ. Other metrics relate to the packet error rate, the quantity of energy per bit (expressed in Joules per bit), etc.

The benefit metric can be defined by BF=Σᵢwᵢ*(Eᵢ) where Eᵢ is the energy efficiency (bit/joule) associated with each component of the network, wᵢ is the weight associated with each Eᵢ. Other metrics relate to spectral efficiency (expressed in bit/s/Hz), deployment efficiency (expressed in bits/euros (or dollars)), etc.

Alternatively or in addition, the restriction can be temporal or spatial. In other terms, for a certain duration and/or as a function of a region of the geographic area, one or the other of the restrictions hereinabove can be selected.

The different optimisation restrictions can be fixed by the operator in charge of deployment of the network.

Once the configuration of the network enabling an offer profile closest to the request profile is determined, S5, the network is configured.

Configuration of the network consists of adapting the number of active base stations, adapting the sending power of base stations, etc.

In the precise case of a mesh network also configuration of defining the itinerary relative to each traffic flow (defined by the routing function).

In other terms, a method for configuration of a telecommunications network located in a geographic area, comprising the following steps, is provided here:
acquiring a use profile of the initial network, this profile originating from experience (this profile can be obtained by means of past use of the network, at recurring time slots);
with each new service request by a terminal of the network, acquiring information relative to the duration of the service requested and determining a criterion as to the possibility of deferring this service;
estimating from acquired information and the criterion at least one theoretical profile of traffic request to arrive in the geographic area over a time period after acquisition;
determining from this estimated traffic request profile at least one configuration of the network defining an offer profile close to the traffic request profile.

An extra step of physical configuration of the network according to the configuration as determined can then be provided.

Prior to the physical configuration step, an optimisation step of the estimated theoretical profile can be provided, by taking into account the use context of the terminal and the content (possibility of deferring the service and its duration).

An optimisation step of the configuration of the network can also be provided as a function of predetermined criteria, for example the consumption of the network.

To clarify these different steps, several concrete examples will now be described within the scope of wireless communications (ideas coming from these examples apply also to other types of telecommunications networks described earlier), by supposing that in a telecommunications network a wireless communications terminal requires a service.

In a first example, this service is instantaneous streaming type, that is, it involves a need for instantaneous transmission and over a determined period, for example reading a video. This service cannot be deferred, but additional content information can be identified: the duration of the video in question. As a function of the position of the terminal at the time of request of the service (context), base stations will be activated to respond to this service in the environment of the terminal, and over the duration of the video. An increase in the capacity of the network can therefore be anticipated during the reading time of the video, then a drop in the capacity of the network at the end of the video period.

In a second example, the relevant service is known as being likely to be deferred (content information). There is for example the case of downloading a set of data of predetermined size (duration of the service). In this case, it can be deduced from context information that a number of configurations of the network in the future can be used to provide the service. The information drawn from experience of the terminal can also be used to increase the scope of these possibilities. In particular, if it is known that the terminal travels a similar path every day between different types of base stations more or less saturated over time allocated to provide the service, several possible configurations of the network can determined over time to provide the service. The choice of configuration finally used can be made at random, or by optimisation of predetermined criteria such as consumption of the network, as described hereinbelow.

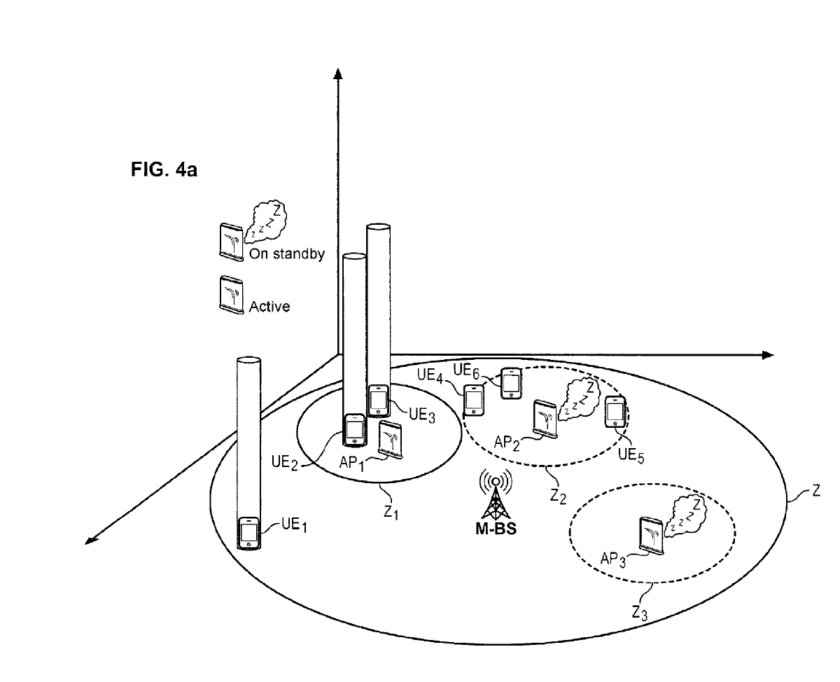

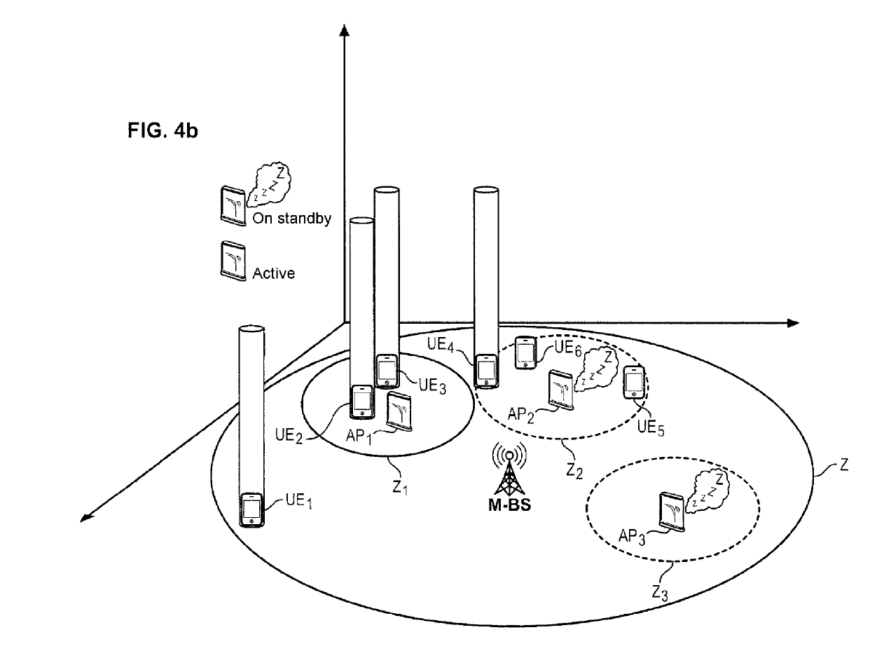

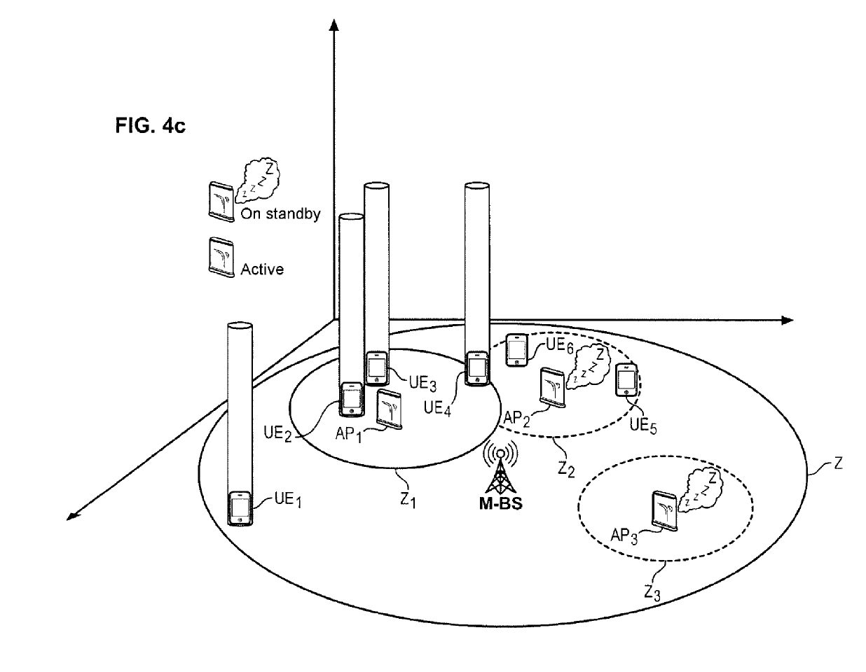

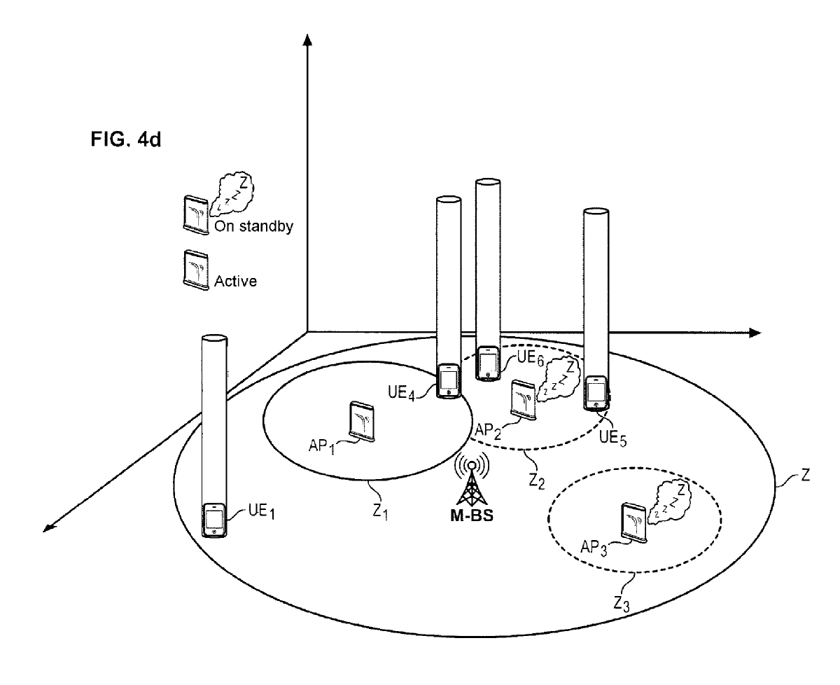

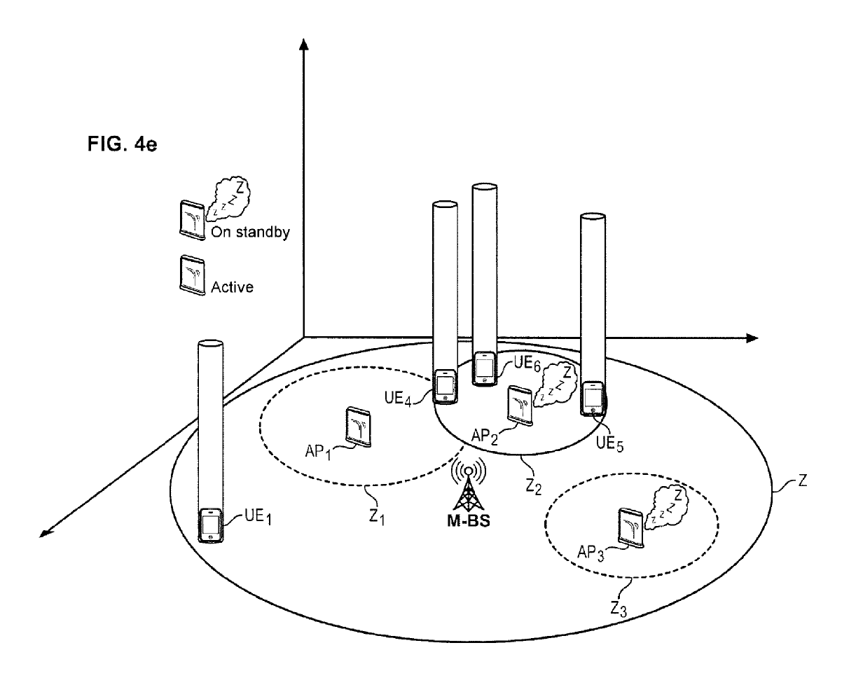

Two embodiments of the method according to the invention are described in relation to FIGS. 4a, 4b, 4c, 4d and 4e.

In the following:
active base station or active terminal is a base station/terminal under power exchanging traffic and operating at power which depends on its charge Pᵢₙ such that Pᵢₙ=P₀+ÜP_{TX} with P₀,Ü and P_{TX} which indicate respectively power at minimal charge, dependence on power consumption per charge and the radio frequency power necessary to satisfy the request profile;
base station or terminal on standby is a base station/terminal under power not exchanging traffic and operating at power P_{idle}<P₀.

In relation to FIG. 4a, this is a situation in an initial situation at an initial instant t0 in which in a given geographic region:
A base station M-BS of a macro-cell is active in a coverage area Z;
Six terminals UE1, UE2, UE3, UE4, UE5, UE6 are present in the coverage area Z;
A local base station AP1 of a femtocell is active and defines a coverage area Z1;
Two local base stations AP2, AP3 of femtocells are on standby;
The terminal UE1 is active and participates in a telephone conference; according to the agenda on its terminal, this telephone conference can last on hour and a half;
The terminal UE2 is active and reads a streaming video; a minute of video remains;
The terminal UE3 is active and is in videoconference mode, according to statistical data, every day at this time when a videoconference takes place during similar periods. At the instant t0 there are thirty seconds of videoconference left;
The terminal UE4 is active and has just started an application for a video game which downloads data in real time;
The terminal UE5 is active and has sent an email at the instant t0 (this application is characterised by a considerable latency time);
The terminal UE6 is on standby;
the terminal UE1 is located at the workplace of its user: it will be static for 5 a certain duration;
The terminals UE2, UE3, UE4 and UE5, UE6 are located at the residence of their user.

The traffic request profile in terms of capacity at the instant t0 is sketched by the vertical bars rising above the terminals UE1, UE2, UE3 in FIG. 4a.

The information relative to the traffic (context and content) acquired and the initial request profile estimate a traffic request profile in the relevant geographic area at an instant t1 (short term).

The information relative to the traffic received or sent (information relative to context and content) deduced from information relative to traffic listed above estimate a traffic request profile in the relevant geographic area at an instant t1 (short-term).

This traffic request profile at the instant t1 is sketched in FIG. 4b.

As seen, it is evident that the terminal UE4 will request a certain capacity.

To determine the configuration of the network for defining an offer profile closest to the traffic request profile, there are three solutions possible:
Activation of the local base station AP2 (on standby at the instant t0);
A power boost of the local base station AP1 (already active at the instant t0) to expand its area coverage so that the terminal UE4 is covered by the local base station AP1;
Linking of the terminal UE4 to the base station of macrocell M-BS.

To determine the optimal configuration network, determining the offer profile of traffic is done under the restriction that the configuration has minimal energy consumption for the requested level of QoS.

For this, the energy consumption of each element of the network is determined. In particular, the consumption Pᵢₙ of base stations AP1, AP2 and M-BS is determined as follows: Pᵢₙ=P₀+ÜP_{TX} with P₀ the power of the base station at minimal load, Ü the dependence on power consumption per load and the necessary power P_{TX} radio frequency at the base station to satisfy the request profile.

It is noted that P₀ and Ü depend on the type of base station. In particular, it is very small for the local base stations (AP1, AP2 and AP3) and mush larger for the base station of macrocell M-BS. In fact, the energy consumption of a local base station depends minimally on its load and transmission power P_{TX}. By comparison, the energy consumption of a base station of macrocell M-BS is quasi proportional to its transmission power P_{TX} (or to its load).

In the case above, the solution according to which the transmission power of local the base station AP1 is increased is the most efficient solution from the energy point of view of the network and at the same time ensures the quality of service requested for the terminal UE4. In fact, activating the local base station AP2 or increasing the load of the base station of macrocell M-BS would visibly increase the energy consumption of the network. Also, activation of the local base station AP2 needs greater reaction time than the latency time available to serve the terminal UE4.

FIG. 4c illustrates the configuration of the resulting network. It is evident relative to FIG. 4a that the terminal UE4 is in the coverage area of the local base station AP1, and that the power of the latter has been increased.

As a variant, from acquired information at the instant t0, the information relative to the acquired traffic (context and content) and the initial request profile estimate a traffic request profile in the relevant geographic area at an instant t2 (average-term).

This traffic request profile at the instant t2 is sketched in FIG. 4d.

With the difference of the traffic request profile estimated for the instant t1:
The terminals UE5, UE6 (located at the residence of their user) will initiate communication and will have to be served;
The terminals UE2 and UE3 will have terminated their applications and will go to standby.

To determine the configuration of the network for defining an offer profile closest to the traffic request profile, two solutions are possible:
Activating the local base station AP2 (on standby at the instant t0);
Linking the terminals UE5 and UE6 to the base station of macrocell MBS.

To determine the optimal configuration network, determining the traffic offer profile is done on condition that configuration of the network ensuring a given level of quality of service for users has minimal energy consumption.

Under this condition, the solution consisting of activating the local base station AP2 and placing the local base station AP1 on standby after linking of the terminal UE4 to the local base station AP2 (handover procedure) produces the network configuration closest to the request profile and has minimal energy consumption.

FIG. 4e illustrates the configuration of the resulting network. It is evident relative to FIG. 4a that the terminals UE4, UE5 and UE6 are in the coverage area defined by the local base station AP2, and that the local base stations AP1 and AP3 are on standby.

An example which illustrates performances in terms of energy consumption of a network configured as per the method of the invention will now be described.

A network of femtocells deployed in a building which can be represented by a 5×5 grid, twenty cellular users are located in the grid and require high-rate video traffic will be considered.

The femtocells are capable of detecting the presence/absence of a user and being deactivated from/placed on standby.

The active femtocells are characterised by energy consumption Pᵢₙ=P₀+ÜP_{TX} with P₀,Ü and P_{TX} which indicate respectively the power of the femtocell at minimal load, the dependence of the power consumption per load and the power radio frequency needed to satisfy the request profile.

By comparison, the femtocells on standby have no data to transmit (no traffic) and are characterised by energy consumption P_{idle}<Pᵢₙ.

The knowledge of the content of the traffic is exploited to allow the femtocells to deactivate only when a user a of traffic is to be transmitted and put on standby when the associated user has no more traffic to receive.

P₀=4.8 W, P_{idle}=2.9 W and Ü=15.

P_{TX} depends on the number of frequency resources used by the femtocell (N_{R}) according to: P_{TX}=N_{R}*P_{RF}, with P_{RF} which is equal to 100 mW.

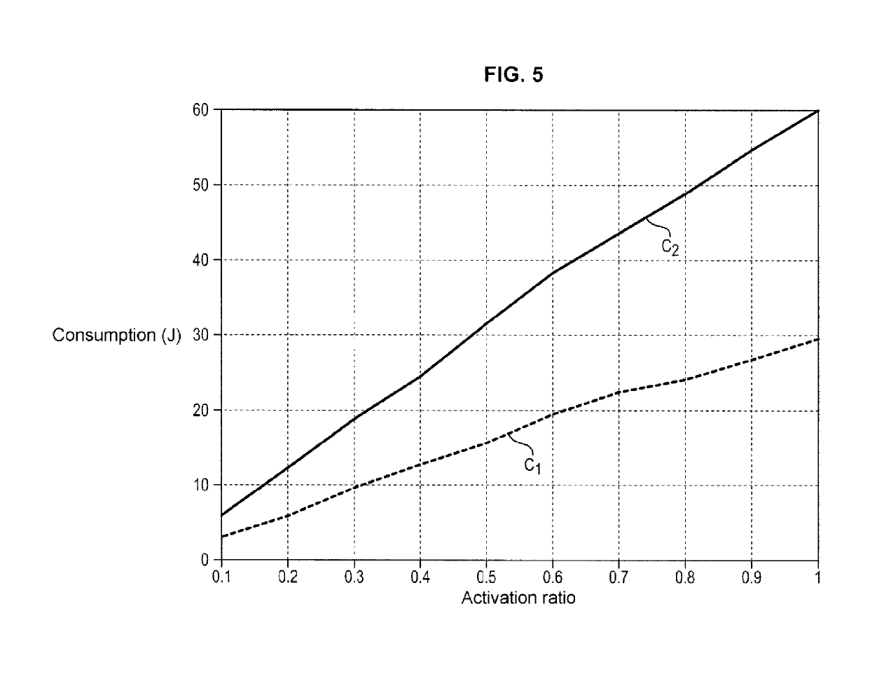

FIG. 5 illustrates comparison of the average energy consumption (in Joules) in the femtocell network when the information of the content is exploited to activate and deactivate the access points (curve C1) with a system which does not run this information (curve C2).

The energy consumption is calculated as a function of the parameter ρ_{d} which measures the probability that a femtocell is installed in an apartment.

These simulations show that a gain of 50% is obtained when the configuration of the network is determined according to the invention.

An example of use of the method of the invention in the case of a mesh network deployed to offer a high-speed wireless Internet connection to passengers of high-speed trains will now be described.

Terminals UE1, UE2 are located in a train moving along a track alongside which base stations AP1, AP2, AP3, AP4 are deployed.

According to a first step, information on the context of user terminals such as their position in the train, the course of the train, the speed of the train and the content of the traffic generated by the applications used by these terminals is acquired.

This information is then aggregated per user and per geographic area then used to estimate one traffic request profile per user then per area in a later given time period.

A benefit function is then defined from the energy consumption of each base station as a function of the number of user terminals served by each base station and the type of traffic expected.

Finally, a configuration of the network for attaining a given minimal level of QoS and maximising said benefit function is determined. In this scenario, the information on the context (that is, the position, course and speed) can be exploited to:
1) dynamically activate and put on standby the base stations of the mesh network;
2) select the shortest path (in terms of latency/hops) to transfer data to the terminals UE1, UE2.

These two functions reduce energy consumption, squandering of resources, latency and prevent failures in the handover process which in real time changes the association between terminals and base stations.

Also, the information on traffic content can be exploited to set up/allocate in real time the capacity (that is, the bandwidth) required/necessary in a specific part of the network.

This approach increases the efficiency of the system and therefore the number of users which can be served by the network.

1. A method for configuration of a telecommunications network located in a geographic area (1) wherein there is at least one terminal (T1-T8) receiving or transmitting traffic relative to a service, the method comprising the steps of:
acquiring (S1) information relative to the traffic received or sent by said at least one terminal (T1-T8), said information comprising a duration of the requested or received service by said terminal;
determining (S2) from the acquired information of a criterion characteristic of a possibility of deferring said requested or received service over time;
estimating (S3), from acquired information and from said determined criterion, of at least one traffic request profile to arrive in the geographic area over a time period after acquisition;
determining (S4) from the estimated traffic request profile of a configuration of the network defining an offer profile closest to the traffic request profile;
configuring (S5) the network according to the configuration as determined, said configuration of the network being defined by the number of active base stations in the geographic area, the power of antennas of terminals and/or base stations and/or the itinerary relative to each traffic flow;
wherein the request profile is a capacity of the network requested in the given geographic area during a given period.

2. The method according to claim 1, wherein the step of estimating (S3) consists of updating, from acquired information, an initial request profile as a function of the profile of each user and previously initialised.

3. The method according to claim 1, wherein the step of determining the configuration of the network defining an offer profile closest to the traffic request profile integrates an optimisation step as a function of a predetermined criterion.

4. The method according to claim 3, wherein said criterion is that said configuration has minimal energy consumption for a given level of service quality.

5. The method according to claim 4, wherein the restriction in minimal energy consumption is a function of cost CF=Σᵢwᵢ*(Pᵢ/Pₘₐₓ) where:
Pᵢ is at least one of the following parameters: capacity, timeframe, wait, packet loss rate, transition time, transitory energy,
Pₘₐₓ is the maximal value of Pᵢ;
wᵢ is the weight associated with each parameter Pᵢ.

6. The method according to claim 5, wherein the restriction in minimal energy consumption is a function of benefit BF=Σᵢwᵢ*(Eᵢ) where Eᵢ is the energy efficiency (bit/joule) associated with each component of the network, wᵢ is the weight associated with each Eᵢ.

7. The method according to claim 1, wherein the information relative to the traffic is sent (S0) at the same time as the traffic.

8. The method according to claim 1, wherein the step of acquiring (S1) consists of using a deep packet inspection technique on the traffic received to extract information relative to the traffic.

9. The method according to claim 1, wherein each terminal comprises an application loaded in memory of the terminal, the method comprising an extraction step by application of information relative to said traffic (S0′), a transmission step (S0″) of extracted information.

10. (canceled)

11. The method according claim 1, wherein the step of configuring (S4) the network is implemented either centralised or distributed.
